(19) United States
(12) Patent Application Publication
(10) Pub. No.: US 2025/0373059 A1
(43) Pub. Date: Dec. 4, 2025

(54) ADAPTIVE DC LINK VOLTAGE REGULATION FOR BATTERY CHARGER

(71) Applicant: Caterpillar Inc., Peoria, IL (US)

(72) Inventor: Malay Bhunia, Paschim Medinipur (IN)

(73) Assignee: Caterpillar Inc., Peoria, IL (US)

(21) Appl. No.: 18/676,901

(22) Filed: May 29, 2024

(51) Int. Cl. H02J 7/00; H02M 1/00

(52) U.S. Cl. CPC H02J 7/007182; H02J 7/0047; H02M 1/0054; H02M 1/007; H02J 2207/20

(57) ABSTRACT

Techniques for implementing an adaptive DC link voltage regulation scheme are described. By adopting an adaptive approach to DC link voltage regulation, such as where the DC link voltage is set as a scaling factor multiplied by the battery voltage, the techniques significantly reduce the switching losses and heat present in conventional two-stage power converters. The techniques use a control system that dynamically adjusts the DC link voltage in real-time, in response to variations in the battery's voltage during the charging cycle. This adaptive regulation of the DC link voltage not only minimizes the heat generated due to switching losses but also optimizes the charging process to suit the requirements of the battery.

### FIELD OF THE DISCLOSURE

This document pertains generally, but not by way of limitation, to power converters and, more specifically, to two-stage power converters.

### BACKGROUND

Two-stage power converters are widely used in the field of power electronics to facilitate the efficient transfer of electrical energy from an AC power source to a load that requires DC power, such as a rechargeable battery. The first stage of these power converters typically includes an AC/DC converter, also known as a rectifier, which converts the alternating current (AC) from the power source into a direct current (DC) output. This DC output is then filtered by a DC link capacitor, which serves to reduce voltage ripple and provide a stable DC voltage. The second stage includes a DC/DC converter that further processes the DC voltage from the DC link capacitor to adjust the voltage level to match the requirements of the load or battery being charged.

Two-stage power converters include power electronic components, such as diodes, transistors, and other switching elements, and their operation is controlled by control circuits to regulate the conversion process. In the AC/DC conversion stage, various topologies such as diode bridges, thyristor-based converters, or active rectifiers with insulated-gate bipolar transistors (IGBTs) may be used, each with its own set of characteristics and performance parameters. The DC/DC conversion stage may utilize different converter topologies as well, including buck, boost, or buck-boost converters, depending on whether the output voltage needs to be stepped down, stepped up, or both.

KR20220046010 describes a high-efficiency charger and a method for driving the same. The charger comprises: an inverter; a converter connected to the inverter and converting DC power output from the inverter to charge a battery; and a control unit controlling at least one operation of the inverter and the converter. A DC link voltage is applied with input of the converter and the DC link voltage changes according to a voltage of the battery in a certain battery voltage range.

### SUMMARY OF THE DISCLOSURE

This disclosure is directed to techniques for implementing an adaptive DC link voltage regulation scheme. By adopting an adaptive approach to DC link voltage regulation, such as where the DC link voltage is set as a scaling factor multiplied by the battery voltage, the techniques of this disclosure significantly reduce the switching losses and heat present in conventional two-stage power converters. The technique uses a control system that dynamically adjusts the DC link voltage in real-time, in response to variations in the battery's voltage during the charging cycle. This adaptive regulation of the DC link voltage not only minimizes the heat generated due to switching losses but also optimizes the charging process to suit the requirements of the battery.

In some aspects, this disclosure is directed to an adaptive DC link voltage control system for a battery charger system, comprising: an AC/DC converter configured for: receiving an AC input voltage from a voltage source; and generating a first DC output voltage; a DC link capacitor coupled with an output of the AC/DC converter; a DC/DC converter configured for receiving the first DC output voltage and for generating a second DC output voltage to charge a battery; a sensor configured for measuring an electrical parameter at the output of the AC/DC converter; and a controller configured for: determining a reference DC link voltage based on a measured voltage of the battery; comparing the reference DC link voltage with a determined DC link voltage, wherein the determined DC link voltage is based on the electrical parameter; and adjusting, based on the comparison, an operation of the AC/DC converter to regulate the determined DC link voltage.

In some aspects, this disclosure is directed to a method of charging a battery using a two-stage battery converter having an AC/DC converter and a DC/DC converter, the method comprising: determining a reference DC link voltage based on a measured voltage of the battery; comparing the reference DC link voltage with a determined DC link voltage, wherein the determined DC link voltage is based on a measured electrical parameter; and adjusting, based on the comparison, an operation of the AC/DC converter to regulate the DC link voltage.

In some aspects, this disclosure is directed to a computer-readable storage device comprising instructions, that when executed by at least one processor, configure the at least one processor to perform operations for: determining a reference DC link voltage based on a measured voltage of a battery; comparing the reference DC link voltage with a determined DC link voltage, wherein the determined DC link voltage is based on a measured electrical parameter; and adjusting, based on the comparison, an operation of an AC/DC converter to regulate the DC link voltage.

### BRIEF DESCRIPTION OF THE DRAWINGS

In the drawings, which are not necessarily drawn to scale, like numerals may describe similar components in different views. Similar components in different views may be described by like numerals. The drawings illustrate generally, by way of example, but not by way of limitation, various embodiments discussed in the present document.

FIG. 1 is a block diagram of an example of an adaptive DC link voltage control system in accordance with this disclosure.

FIG. 2 is a block diagram of an example of the controller of FIG. 1.

FIG. 3 is a flow diagram of an example of a method of charging a battery using a two-stage battery converter having an AC/DC converter and a DC/DC converter.

### DETAILED DESCRIPTION

Conventional two-stage power converters use a fixed DC link voltage, which is the voltage between the first-stage AC/DC converter and the second-stage DC/DC converter. The present inventor has recognized that the use of the fixed DC link voltage results in increased heat generation within the charger's power electronics due to switching and conduction losses. This excess heat necessitates increased cooling strategies, such as greater coolant flow and higher cooling fan speeds, to dissipate the heat effectively. However, these measures result in additional energy consumption, thereby reducing the overall efficiency of the charger and potentially impacting the durability and cost-effectiveness of the system. The present inventor has recognized a need for a two-stage power converter that has improved efficiency and lower cost to cool over conventional two-stage power converters.

This disclosure is directed to techniques for implementing an adaptive DC link voltage regulation scheme. By adopting an adaptive approach to DC link voltage regulation, such as where the DC link voltage is set as a scaling factor multiplied by the battery voltage, the techniques of this disclosure significantly reduce the switching losses and heat present in conventional two-stage power converters. The technique uses a control system that dynamically adjusts the DC link voltage in real-time, in response to variations in the battery's voltage during the charging cycle. This adaptive regulation of the DC link voltage not only minimizes the heat generated due to switching losses but also optimizes the charging process to suit the requirements of the battery.

Such a system enhances the efficiency of the charger, reduces the need for extensive cooling, and extends the life of both the charger and the battery. This approach represents a significant advancement in the field of battery charger system technology, offering a practical and effective means to address the thermal management challenges associated with traditional fixed DC link voltage designs.

FIG. 1 is a block diagram of an example of an adaptive DC link voltage control system 100 in accordance with this disclosure. The adaptive DC link voltage control system 100 includes a two-stage battery charger that includes an AC/DC converter 102 coupled with a DC/DC converter 104. The AC/DC converter 102 is configured for receiving an AC input voltage 106 from a voltage source 108, e.g., a grid, a microgrid, or another source of AC voltage. The AC/DC converter 102 is configured for generating a first DC output voltage at an output 110 of the AC/DC converter 102 using switching elements 114.

The DC/DC converter 104 is coupled with the output 110 and configured for receiving the first DC output voltage and for generating a second DC output voltage V2 using switching elements 112 to charge a battery 116. The battery 116 may include a plurality of battery strings, where each battery string has at least one battery cell. In some examples, a battery string includes a battery module. A DC link capacitor 118 is coupled with the output 110 of the AC/DC converter 102 between the AC/DC converter 102 and the DC/DC converter 104.

The adaptive DC link voltage control system 100 further includes a sensor configured for measuring an electrical parameter at the output 110 of the AC/DC converter 102. In some examples, the electrical parameter is current and the sensor is a current sensor 120 configured for measuring a current flowing through the DC link capacitor 118. In other examples, the electrical parameter is voltage and the sensor is a first voltage sensor 122 configured for measuring the first DC output voltage at the output 110.

A second voltage sensor 124 is configured for measuring a voltage of the battery 116. In some examples, the second voltage sensor 124 is in communication with a battery management system (BMS) controller, such as a BMS controller 128, via a communication link 130. In some examples, the communication link 130 is a wireless link and, in other examples, the communication link 130 is a wired link.

The adaptive DC link voltage control system 100 further includes a controller 126. The controller 126 is configured for generating switching gate pulse signals 132 to control the operation of the switching elements 114 of the AC/DC converter 102 and the switching elements 112 of the DC/DC converter 104. The controller 126 is configured for receiving signals 134 from the current sensor 120 (if present), signals 136 from the first voltage sensor 122 (if present), and signals 138 from the BMS controller 128, including signals from the second voltage sensor 124.

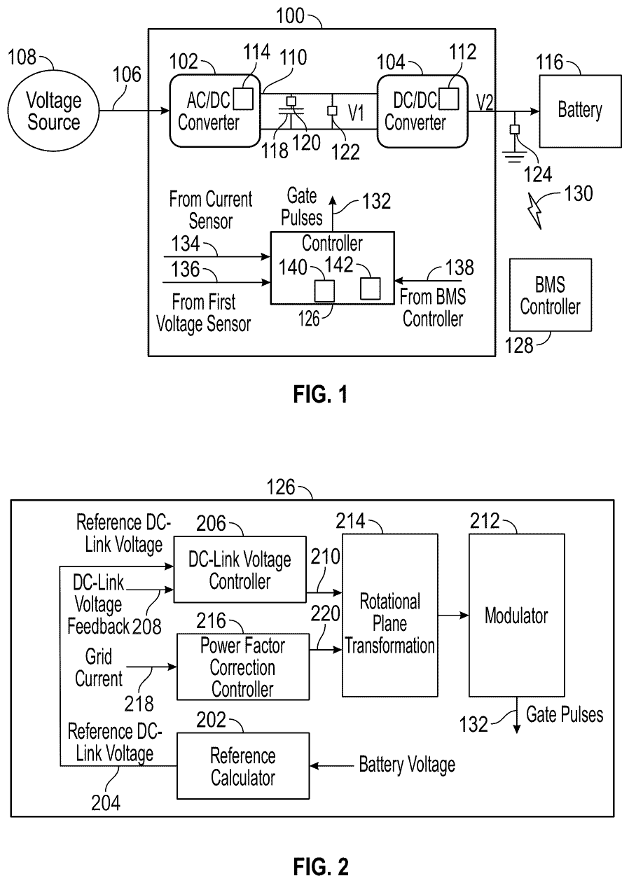

Using the techniques of this disclosure, the controller 126 dynamically adjusts a DC link voltage V1 in real-time, in response to variations in the voltage of the battery 116 during the charging cycle. As described in more detail below with respect to FIG. 2, to dynamically adjust the DC link voltage V1 in real-time, the controller 126 is configured for determining a reference DC link voltage based on a measured voltage of the battery. The controller 126 is configured for comparing the reference DC link voltage with a determined DC link voltage, where the determined DC link voltage is based on the electrical parameter. The controller 126 is configured for adjusting, based on the comparison, an operation of the AC/DC converter to regulate the determined DC link voltage.

The controller 126 includes at least one processor 140 and a computer-readable storage device, such as a memory 142. The memory 142 includes instructions, that when executed by the processor 140, configure the processor 140 to perform operations described in this disclosure.

FIG. 2 is a block diagram of an example of the controller 126 of FIG. 1. The controller 126 includes a reference calculator 202. The reference calculator 202 receives a representation of the measured voltage of the battery 116 of FIG. 1, such as measured by the second voltage sensor 124 of FIG. 1, and determines a reference DC link voltage 204 based on the measured voltage of the battery. The reference calculator 202 adjusts the reference DC link voltage 204 to maintain a linear relationship between the determined DC link voltage V1 and the measured voltage of the battery. For example, the reference calculator 202 sets the reference DC link voltage 204 equal to a scaling factor multiplied by the measured voltage of the battery:

$${V}_{R E F} = x * {V}_{B A T}$$

where V_{REF} is the reference DC link voltage 204, x is the scaling factor, and V_{BAT} is the measured voltage of the battery. The scaling factor may be chosen based on the specific converter topology and the characteristics of the battery being charged, allowing for a more efficient and cooler operation of the battery charger.

The controller 126 adjusts the operation of the AC/DC converter to achieve and maintain a linear relationship between the determined DC link voltage and the measured voltage of the battery over an entire range of battery voltages. That is, the linear relationship is maintained between the determined DC link voltage and the measured voltage of the battery over a range of voltages that includes a discharged voltage of the battery and a fully charged voltage of the battery. The state of charge (SOC) of a battery is a measurement that represents the present charge level of the battery relative to its maximum capacity. The SOC may be expressed as a percentage, where 100% SOC indicates that the battery is fully charged and 0% SOC indicates that the battery is completely discharged. Using the techniques of this disclosure, the linear relationship is maintained between the determined DC link voltage and the measured voltage of the battery over the entire range of SOC levels of a battery (0% SOC to 100% SOC).

In some examples, the scaling factor is based on a battery characteristic, such as its chemistry (lithium ion, nickel-metal hydride, etc.), internal impedance, or other characteristics. In other examples, the scaling factor is based on a characteristic, e.g., type, of the AC/DC converter, such as whether the AC/DC converter is a buck converter, a boost converter, or a buck-boost converter.

The controller 126 includes a DC link voltage controller 206. The DC link voltage controller 206 is configured for receiving the reference DC link voltage 204 and a DC link voltage feedback 208, which represents the determined DC link voltage. The determined DC link voltage may be measured or calculated. In some examples, the DC link voltage feedback 208 is determined by the voltage measured by the first voltage sensor 122 of FIG. 1. In other examples, the DC link voltage feedback 208 is determined by the current measured by the current sensor 120 of FIG. 1. For example, the controller 126 may calculate the voltage using the current flowing through the DC link capacitor 118, as measured by the current sensor 120, and by integrating the current over time. The DC link voltage controller 206 then compares the reference DC link voltage 204 with the DC link voltage feedback 208, e.g., the determined DC link voltage, such as where the determined DC link voltage is based on a measured electrical parameter, e.g., current as measured by the current sensor 120 or voltage as measured by the first voltage sensor 122.

Based on the comparison, the DC link voltage controller 206 is configured for generating a signal 210 that adjusts an operation of the AC/DC converter 102 of FIG. 1 to regulate the determined DC link voltage, such as in response to changes in the measured voltage of the battery during a charging cycle. In some examples, the controller 126 includes a modulator 212 configured for generating the switching gate pulse signals 132 of FIG. 1, which control the operation of the switching elements. The signal 210 is applied to the modulator 212 to adjust an operation of the AC/DC converter 102 of FIG. 1, such as to adjust a duty cycle of the switching elements 114 of the AC/DC converter 102. In this manner, the techniques of this disclosure maintain a voltage difference between the determined DC link voltage and the measured voltage of the battery, such as determined by the scaling factor.

In some examples, the controller 126 includes a rotational plane transformation 214, such as a DQ to ABC transform or a αβ to ABC transform. This transformation converts two-axis quantities, which are time and angle-dependent, into a three-axis coordinate system that rotates with the voltage source 108. When present, the controller 126 adjusts the operation of the AC/DC converter 102 of FIG. 1 after performing the rotational plane transformation.

In some examples, the controller 126 includes a power factor correction controller 216. The power factor correction controller 216 receives a representation of a grid current 218. The power factor correction controller 216 compares a phase of the grid current with a phase of the voltage source 108. If they are not in phase, the power factor correction controller 216 generates a signal 220 to adjust the operation of the AC/DC converter 102 to shape the current so that it is in phase with the voltage.

Using these techniques, before energy transfer to the battery, the controller 126 automatically tunes the DC link voltage V1 based on the terminal voltage of the battery. During energy transfer to the battery, the controller 126 automatically tunes the DC link voltage V1 based on the present terminal voltage of the battery. Further, the controller 126 automatically tunes the reference DC link voltage 204 automatically tunes for different batteries. For example, if a scaling factor of 10% is desirable, then it does not matter if the battery is a 100-volt battery, a 500-volt battery, or a 1000-volt battery. The controller 126 automatically tunes the reference DC link voltage 204 to be 10% above the measured voltage of the battery, making the techniques battery independent.

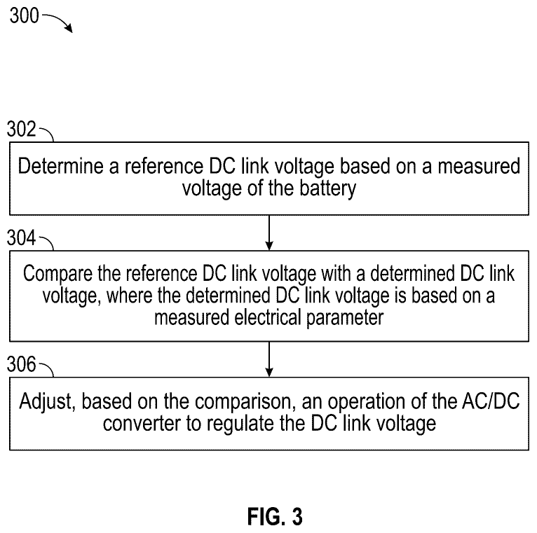

FIG. 3 is a flow diagram of an example of a method of charging a battery using a two-stage battery converter having an AC/DC converter and a DC/DC converter.

At block 302, the method 300 includes determining a reference DC link voltage based on a measured voltage of the battery. For example, the reference calculator 202 of the controller 126 of FIG. 2 determines a reference DC link voltage 204 by setting the reference DC link voltage 204 equal to a scaling factor multiplied by the measured voltage of the battery 116.

At block 304, the method 300 includes comparing the reference DC link voltage with a determined DC link voltage, where the determined DC link voltage is based on a measured electrical parameter. For example, the DC link voltage controller 206 of the controller 126 of FIG. 2 compares the reference DC link voltage 204 with a DC link voltage feedback 208, such as a measured DC link voltage or a DC link voltage determined based on a current to the DC link capacitor 118.

At block 306, the method 300 includes adjusting, based on the comparison, an operation of the AC/DC converter to regulate the DC link voltage. For example, the DC link voltage controller 206 outputs a signal 210 to adjust switching gate pulse signals 132 of the AC/DC converter 102, such as to adjust a duty cycle of its switching elements 114.

In some examples, adjusting the duty cycle of the switching elements of the AC/DC converter includes maintaining a voltage difference between the determined DC link voltage and the measured voltage of the battery.

In some examples, the method 300 includes adjusting the reference DC link voltage to maintain a linear relationship between the determined DC link voltage and the measured voltage of the battery.

The memory 142 includes instructions, that when executed by the processor 140, configure the processor 140 to perform the operations described in this disclosure, including those of the method 300.

### Industrial Applicability

The adaptive DC link voltage control system for a battery charger system described in this disclosure exhibits significant industrial applicability, addressing the need for efficient and reliable battery charging solutions across various sectors. The system's design ensures that the DC link voltage is dynamically adjusted to maintain a voltage difference between the DC link and the battery's measured voltage. This feature is advantageous in industrial settings where battery-powered equipment and vehicles require frequent and rapid charging, such as in material handling, logistics, and transportation industries. Moreover, the system's ability to dynamically adjust the reference DC link voltage based on real-time battery measurements allows for optimized charging efficiency, which may lead to reduced energy consumption and lower operational costs.

The industrial applicability of this invention is further underscored by its compatibility with advanced battery management systems (BMS), which may communicate charging parameters to the controller. This ensures that the charging process is tailored to the specific requirements of the battery. As industries continue to move towards electrification and seek sustainable energy solutions, the adaptive DC link voltage control system provides a valuable tool for enhancing the efficiency and reliability of battery charging processes, thereby supporting the broader adoption of green technologies and contributing to environmental sustainability.

### Various Notes

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. An adaptive DC link voltage control system for a battery charger system, comprising:
an AC/DC converter configured for:
receiving an AC input voltage from a voltage source; and
generating a first DC output voltage;
a DC link capacitor coupled with an output of the AC/DC converter;
a DC/DC converter configured for receiving the first DC output voltage and for generating a second DC output voltage to charge a battery;
a sensor configured for measuring an electrical parameter at the output of the AC/DC converter; and
a controller configured for:
determining a reference DC link voltage based on a measured voltage of the battery;
comparing the reference DC link voltage with a determined DC link voltage, wherein the determined DC link voltage is based on the electrical parameter; and
adjusting, based on the comparison, an operation of the AC/DC converter to regulate the determined DC link voltage.

2. The adaptive DC link voltage control system of claim 1, wherein the controller configured for adjusting, based on the comparison, the operation of the AC/DC converter to regulate the determined DC link voltage is configured for:
adjusting a duty cycle of switching elements of the AC/DC converter.

3. The adaptive DC link voltage control system of claim 2, wherein the controller configured for adjusting the duty cycle of the switching elements of the AC/DC converter is configured for:
maintaining a voltage difference between the determined DC link voltage and the measured voltage of the battery.

4. The adaptive DC link voltage control system of claim 1, wherein the controller is configured for:
adjusting the reference DC link voltage to maintain a linear relationship between the determined DC link voltage and the measured voltage of the battery.

5. The adaptive DC link voltage control system of claim 4, wherein the controller configured for adjusting the reference DC link voltage to maintain a linear relationship between the determined DC link voltage and the measured voltage of the battery is configured for:
adjusting the operation of the AC/DC converter to achieve and maintain the linear relationship between the determined DC link voltage and the measured voltage of the battery over an entire range of battery voltages.

6. The adaptive DC link voltage control system of claim 4, wherein the controller configured for adjusting the reference DC link voltage to maintain a linear relationship between the determined DC link voltage and the measured voltage of the battery is configured for:
setting the reference DC link voltage equal to a scaling factor multiplied by the measured voltage of the battery.

7. The adaptive DC link voltage control system of claim 6, wherein the scaling factor is based on a characteristic of the battery.

8. The adaptive DC link voltage control system of claim 6, wherein the scaling factor is based on a characteristic of the AC/DC converter.

9. The adaptive DC link voltage control system of claim 1, wherein the controller configured for adjusting, based on the comparison, the operation of the AC/DC converter is configured for:
adjusting the determined DC link voltage in response to changes in the measured voltage of the battery during a charging cycle.

10. The adaptive DC link voltage control system of claim 1, wherein the electrical parameter is voltage, and wherein the sensor is a voltage sensor configured for measuring the DC link voltage across the DC link capacitor.

11. The adaptive DC link voltage control system of claim 1, wherein the electrical parameter is current, wherein the sensor is a current sensor configured for measuring a current flowing to the DC link capacitor, and wherein the determined DC link voltage is based on the current.

12. The adaptive DC link voltage control system of claim 1, further comprising:
a voltage sensor configured for measuring a voltage of the battery.

13. A method of charging a battery using a two-stage battery converter having an AC/DC converter and a DC/DC converter, the method comprising:
determining a reference DC link voltage based on a measured voltage of the battery;
comparing the reference DC link voltage with a determined DC link voltage, wherein the determined DC link voltage is based on a measured electrical parameter; and
adjusting, based on the comparison, an operation of the AC/DC converter to regulate the DC link voltage.

14. The method of claim 13, wherein adjusting, based on the comparison, the operation of the AC/DC converter to regulate the determined DC link voltage includes:
adjusting a duty cycle of switching elements of the AC/DC converter.

15. The method of claim 14, wherein adjusting the duty cycle of the switching elements of the AC/DC converter includes:
maintaining a voltage difference between the determined DC link voltage and the measured voltage of the battery.

16. The method of claim 13, comprising:
adjusting the reference DC link voltage to maintain a linear relationship between the determined DC link voltage and the measured voltage of the battery.

17. The method of claim 16, wherein adjusting the reference DC link voltage to maintain the linear relationship between the determined DC link voltage and the measured voltage of the battery includes:
setting the reference DC link voltage equal to a scaling factor multiplied by the measured voltage of the battery.

18. A computer-readable storage device comprising instructions, that when executed by at least one processor, configure the at least one processor to perform operations for:
determining a reference DC link voltage based on a measured voltage of a battery;
comparing the reference DC link voltage with a determined DC link voltage, wherein the determined DC link voltage is based on a measured electrical parameter; and
adjusting, based on the comparison, an operation of an AC/DC converter to regulate the DC link voltage.

19. The computer-readable storage device of claim 18, wherein adjusting, based on the comparison, the operation of the AC/DC converter to regulate the DC link voltage includes:
adjusting a duty cycle of switching elements of the AC/DC converter.

20. The computer-readable storage device of claim 18, comprising instructions, that when executed by at least one processor, configure the at least one processor to perform operations for:
adjusting the reference DC link voltage to maintain a linear relationship between the determined DC link voltage and the measured voltage of the battery.
